(19) United States
(12) Patent Application Publication
(10) Pub. No.: US 2006/0207368 A1
(43) Pub. Date: Sep. 21, 2006

(54) Rack and optical drive utilizing the same

(75) Inventors: Wen-Guang Hao, Jiangsu (CN); Yan-Ping Shen, Jiangsu (CN); Xue-Feng Tan, Jiangsu (CN)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/373,242

(22) Filed: Mar. 13, 2006

(30) Foreign Application Priority Data
Mar. 15, 2005 (TW) 94107831

(51) Int. Cl. F16H 1/04

(52) U.S. Cl. 74/422

(57) ABSTRACT

A rack and an optical drive utilizing the same. The rack comprises at least one full tooth, a first tooth lower than the full tooth, and a second tooth with the same height as the full tooth. The second tooth is adjacent to the first tooth and comprises a chamfer which is on the tooth crest and faces the first tooth to prevent the rack from blocking the gear.

### BACKGROUND

The invention relates to a rack, and in particular to a rack capable of blocking a gear during a meshing process.

FIG. 1 depicts a conventional optical drive. A optical drive 100 comprises a chassis 10, a tray 20, a gear 30, a motor 40 and a cam 50. The tray 20 comprises a guide groove 22 and a rack 24. The motor 40 drives the gear 30 which meshes with the rack 24 to drive the tray 20, whereby the tray 20 can slide on the chassis 10 to be received and ejected.

When the tray 20 is about to be completely received in the chassis 10, the driving mechanism is changed. Referring to FIGS. 2a and 2b, a gear 80 on the motor 40 drives a gear 70 to rotate the gear 30 which meshes with the rack 24 on the tray 20, thereby driving the tray 20. When the tray 20 is about to be accommodated in the chassis 10, the guide groove 22 joins a guide element 52 on the cam 50. Because the guide groove 22 is inclined by 45°, the cam 50 is moved rightward by the tray 20. Referring to FIGS. 2c to 2e, the cam 50 is provided with a rack 54 which begins to mesh with the gear 30 when the cam 50 is moved rightward. When the gear 30 is released from the rack 24 and meshes with the rack 54 completely, the cam 50 is moved rightward by the gear 30 and drives the tray 20 until the tray 20 is completely received in the chassis 10.

Motion analysis of each element is described in the followings. FIG. 3 is an enlarged view of FIG. 2c. The linear velocity of rack 24, which meshes with the gear 30, is V, i.e. the velocity of tray 20 is also V. As the cam 50 is driven by the guide groove 22 inclined by 45° on the tray 20 and constrained to move rightward and leftward only (in the x direction), the velocity of the cam 50 is, therefore, also V. Thus the velocity of the rack 54 in the x direction is V. A full tooth 31 of the gear 30 has a linear velocity V which has a horizontal component V1. V1=Vcosθ, wherein θ is the angle between V and V1, hence V1 is less than V. This means that the linear velocity of the rack 54 is different from the horizontal velocity of the full tooth 31. The velocity difference in the x direction can easily cause blockage when the rack 54 begins to mesh with the gear 30.

To solve the described problem, two conventional methods are used. One is to increase the number of teeth on the gear 30. This increases the diameter of the gear 30. In this way, θ is decreased to approximate V1 to V, i.e. horizontal velocities of the rack 54 and the gear 30 are matched as closely as possible to facilitate meshing therebetween. The increase in the diameter of the gear 30 can, however, cause variation in the position of gear 30 and the cam 50 and the size variation of other elements in the optical drive.

The other method is to decrease the height of the first tooth 55 of the rack 54 to dodge the full tooth of the gear 30 and mesh smoothly with the gear 30 as shown in FIG. 3 so as to speed the rotation of the gear 30 to match the horizontal velocities of the rack 54 and the gear 30. The method depends greatly on the radial position of the rack 54 and mesh angle of the gear 30, thus tolerance fit between each element must be precise. This increases design complexity and manufacturing cost. In practice, the cam 50 is not completely constrained in the y direction due to tolerance fit and size considerations. The cam 50 can shift slightly in the y direction as shown in FIG. 4a. As the rack 54 shifts slightly away from the gear 30, the second tooth 56 of the rack 54 may block the gear 30 before the first tooth 55 meshes with the gear 30 completely as shown in FIG. 4b.

### SUMMARY

An embodiment of a rack according to the invention comprises at least one full tooth, a first tooth lower than the full tooth, and a second tooth with the same height as the full tooth. The second tooth is adjacent to the first tooth and comprises a chamfer which is on the tooth crest and faces the first tooth to prevent the rack from blocking the gear.

The thickness of the first tooth is sufficient to prevent the second tooth from blocking the gear when the first tooth contacts the gear. The thickness of the first tooth is less than that of the full tooth, and the thickness of the second tooth is the same as that of the full tooth. The chamfer has a cutting length and a cutting angle. The cutting length is not less than the difference between the thickness on the standard pitch line of the second tooth and the thickness on the standard pitch line of the first tooth. The cutting angle is not less than the critical angle at which the second tooth blocks one tooth of the gear.

### BRIEF DESCRIPTION OF THE DRAWINGS

The invention can be more fully understood by reading the subsequent detailed description and examples with references made to the accompanying drawings, wherein:

FIG. 1 is a schematic view of a conventional optical drive;

FIGS. 2a to 2e show the motion of a tray which is immediately prior to being almost completely received in a chassis of a conventional optical drive;

FIG. 3 is an enlarged view of FIG. 2c;

FIGS. 4a and 4b show that the rack blocking the gear;

FIG. 5 is a schematic view of an embodiment of a rack according to the invention; and

FIG. 6 is an enlarged view of portion A of FIG. 5.

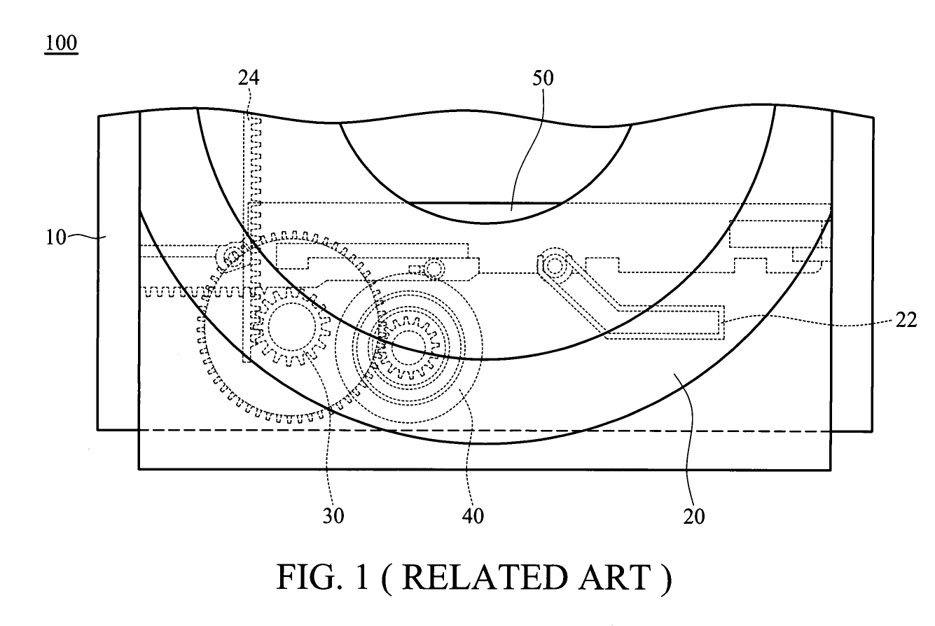

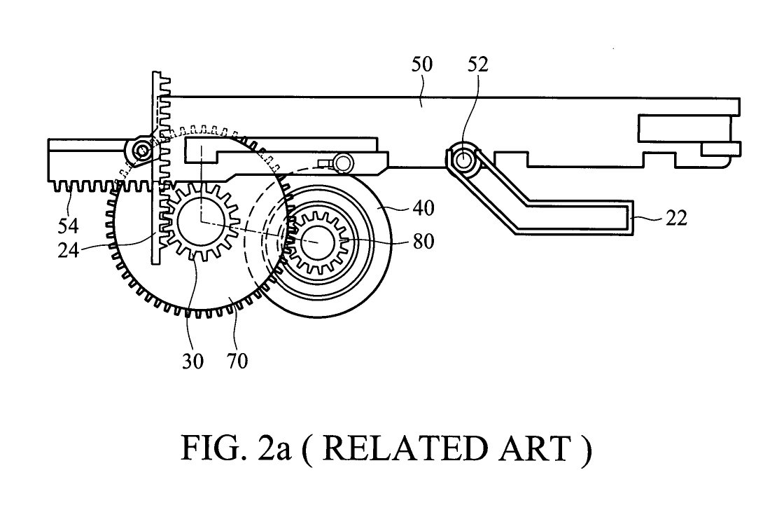

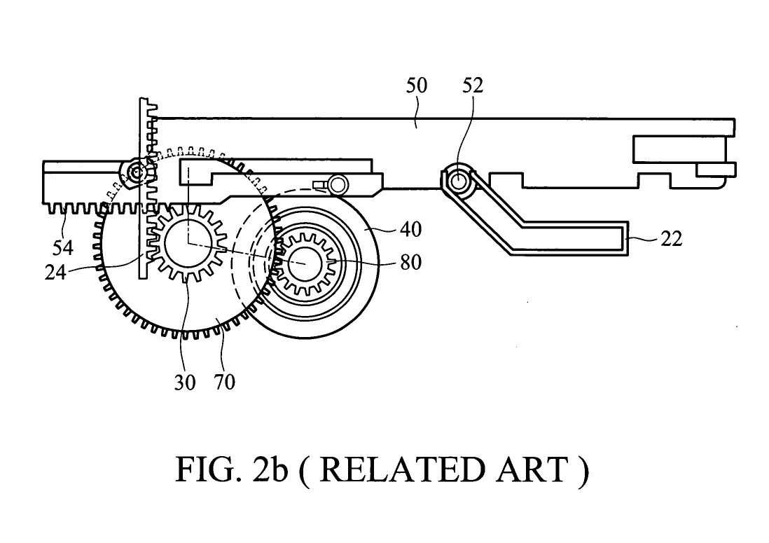

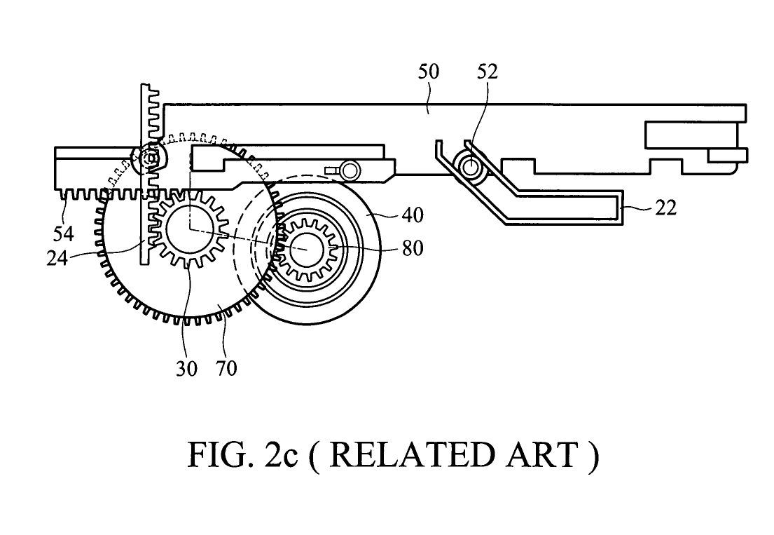

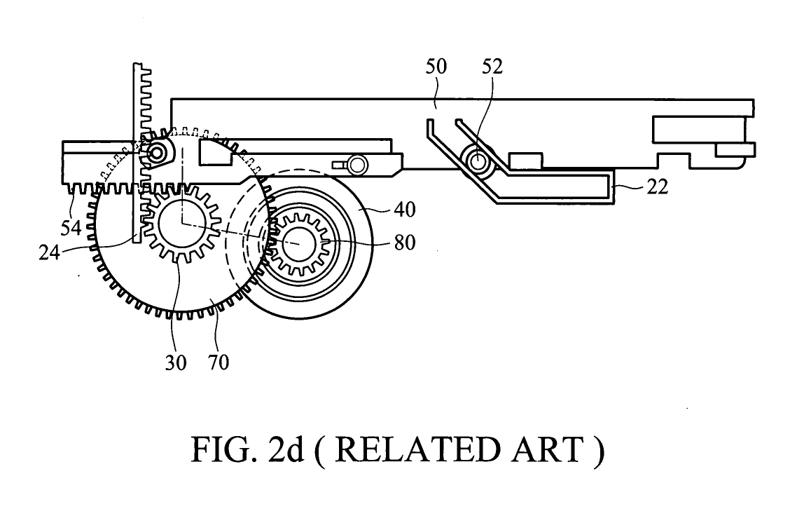

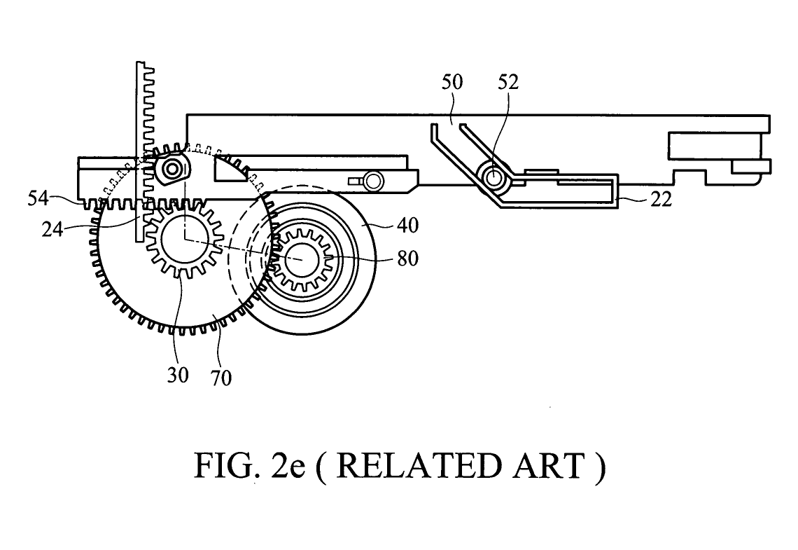

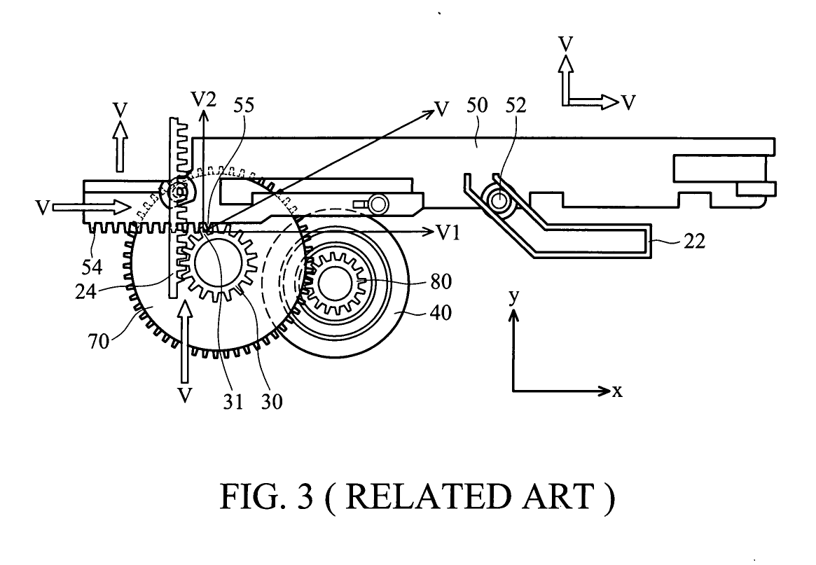

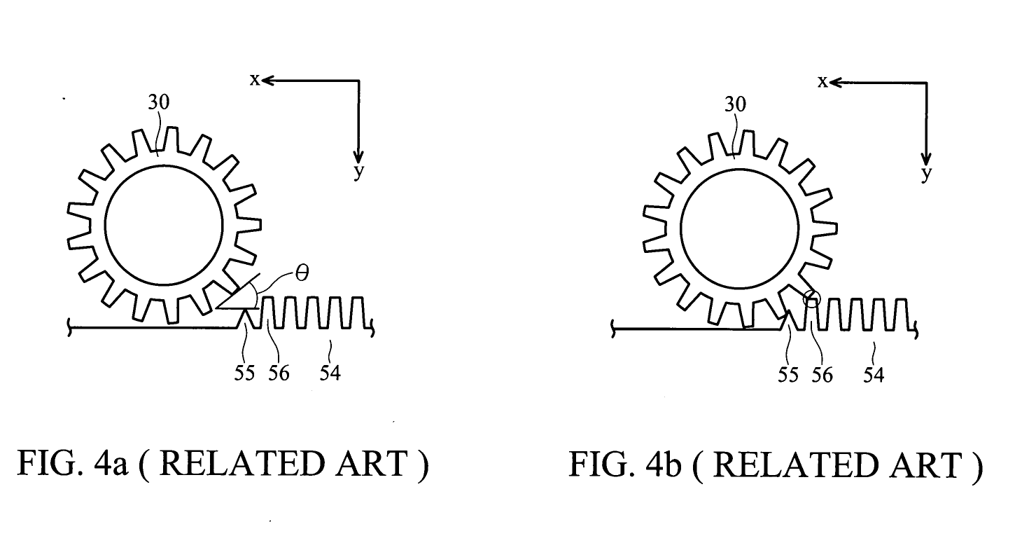

### DETAILED DESCRIPTION

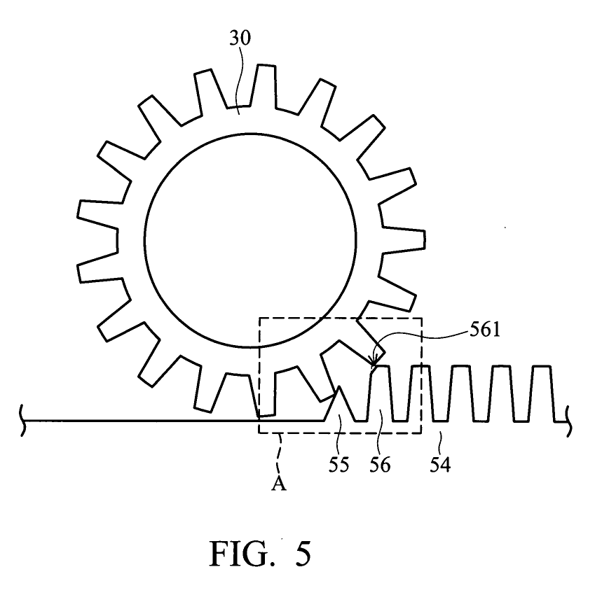

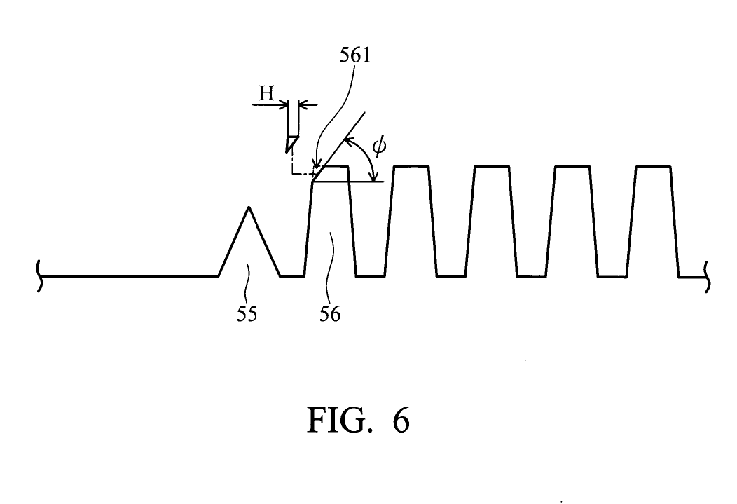

To solve the blockage problem, the thickness of the first tooth 55 of the rack 54 according to the invention is increased slightly, and the height the first tooth 55 is also increased slightly. The crest of the second tooth 56 is cut by an appropriate cutting length H and an appropriate cutting angle φ with respect to the horizontal direction to form a chamfer 561 which faces the first tooth 55 as shown in FIG. 5.

The increase of the tooth thickness of the first tooth 55 advances the time of the contact between the first tooth 55 and the gear 30 so that the first tooth 55 and the gear 30 are meshed as early as possible. The chamfer 561 provides more space for the second tooth 56 to dodge the full tooth of the gear 30 if the first tooth 55 has not meshed with the gear 30 completely due to insufficient tooth thickness.

The cutting length which is not less than the difference between the thickness on the standard pitch line of the second tooth 56 and the thickness on the standard pitch line of the first tooth 55 compensates for the difference in thickness of a full tooth of the rack 54 and the first tooth 55. The cutting angle φ is not less than the critical angle between a full tooth of the gear 30 and the first tooth 55 at which the blockage therebetween occurs.

The invention provides a method to solve the described problem in two ways. The first increases the tooth thickness to advance the time at which meshing between the first tooth and the gear occurs, and the second is to form a chamfer on the crest enabling the second tooth to dodge the tooth of the gear.

Although an optical drive is described, it is not limited thereto. The invention can be applied to any device which needs smooth meshing between a gear and a rack.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A rack for meshing a gear, comprising:
at least one full tooth;
a first tooth lower than the full tooth; and
a second tooth with the same height as the full tooth, adjacent to the first tooth and comprising a chamfer disposed on the tooth crest and facing the first tooth.

2. The rack as claimed in claim 1, wherein the thickness of the first tooth is sufficient to prevent the second tooth from blocking the gear when the first tooth contacts the gear.

3. The rack as claimed in claim 1, wherein the thickness of the first tooth is less than that of the full tooth, and the thickness of the second tooth is the same as that of the full tooth.

4. The rack as claimed in claim 1, wherein the chamfer has a cutting length which is not less than the difference between the thickness on the standard pitch line of the second tooth and the thickness on the standard pitch line of the first tooth.

5. The rack as claimed in claim 1, wherein the chamfer has a cutting angle which is not less than the critical angle at which the second tooth blocks one tooth of the gear.

6. An optical drive, comprising:
a chassis;
a tray sliding on the chassis and having a guide groove;
a driving element driving the tray to slide on the chassis and having a gear; and
a cam joining the guide groove and having a rack meshing with the gear, the rack comprising:
at least one full tooth;
a first tooth lower than the full tooth; and
a second tooth with the same height as the full tooth, adjacent to the first tooth and comprising a chamfer disposed on the tooth crest and facing the first tooth,
wherein the rack meshes with the gear when the cam joins the guide groove and is moved by the gear, thereby sliding the tray on the chassis.

7. The optical drive as claimed in claim 6, wherein the thickness of the first tooth is sufficient to prevent the second tooth from blocking the gear when the first tooth contacts the gear.

8. The optical drive as claimed in claim 6, wherein the thickness of the first tooth is less than that of the full tooth, and the thickness of the second tooth is the same as that of the full tooth.

9. The optical drive as claimed in claim 6, wherein the chamfer has a cutting length which is not less than the difference between the thickness on the standard pitch line of the second tooth and the thickness on the standard pitch line of the first tooth.

10. The optical drive as claimed in claim 6, wherein the chamfer has a cutting angle which is not less than the critical angle at which the second tooth blocks one tooth of the gear.
